(19) United States
(12) Patent Application Publication
(10) Pub. No.: US 2009/0006834 A1
(43) Pub. Date: Jan. 1, 2009

(54) PROXIED FIRMWARE UPDATES

(76) Inventors: Michael Rothman, Puyallup, WA (US); Vincent J. Zimmer, Federal Way, WA (US)

Correspondence Address: SCHWEGMAN, LUNDBERG & WOESSNER, P.A., P.O. BOX 2938, MINNEAPOLIS, MN, 55402, US

(21) Appl. No.: 11/771,788

(22) Filed: Jun. 29, 2007

(51) Int. Cl. G06F 9/445

(52) U.S. Cl. 713/2

(57) ABSTRACT

The subject mater herein relates to computing systems and, more particularly, to proxied firmware updates. Some embodiments provide one or more of systems, methods, software, and firmware that, upon receiving a source of power, initialize an out-of-band controller that, may initialize a network interface to facilitate communication by the out-of-band controller with network resources and receive a firmware update payload from a remote network source over the network interface. These, and other embodiments may also include powering on a computing system including a BIOS and initializing at least a portion of the BIOS. If the computing system supports proxied firmware updates and a firmware update exists in a memory, such embodiments retrieve the payload and launching the payload to implement the firmware update.

### TECHNICAL FIELD

The subject mater herein relates to computing systems and, more particularly, to proxied firmware updates.

### BACKGROUND INFORMATION

When initiating a firmware update, there is a prescribed mechanism that is allowed in modern BIOS's. However, there is a distinct possibility of failure depending on the underlying operating system or platform support. In addition, initiating a remote firmware update to-date has been difficult at best because there has been a requirement for the receiving operating system to have an agent present and the out-of-band management controller (e.g., Active Management Technology “AMT” or Baseboard Management Controller “BMC”) may not have enough non-volatile storage to proxy such a request.

### BRIEF DESCRIPTION OF THE DRAWINGS

FIG. 1 is a logical schematic diagram of a system according to an example embodiment.

FIG. 2 is a logical block flow diagram of a method according to an example embodiment.

FIG. 3 is a logical block flow diagram of a method according to an example embodiment.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to he understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

Today there is the ability to initiate a communication from an operating system runtime phase of platform operations so that one can initiate a request for a firmware update. This is allowed by standard firmware interfaces by passing capsules to the firmware with both virtual and physical mapping. Depending on the intended consumption, the firmware may process the capsule immediately. If the payload should persist across a system reset, the reset value returned from EFI_QUERYCAPSULECAPABILITIES is passed into RESETSYSTEM( ) and will cause the capsule to be processed by the firmware as part of the reset process. For example:

| | |
|---|---|
| Typedef | |
| EFI_STATUS | |
| UpdateCapsule ( | |
| IN EFI_CAPSULE_HEADER | **CapsuleHeaderArray, |
| IN UINTN | CapsuleCount |
| IN EFI_PHYSICAL_ADDRESS | ScatterGatherList |
| OPTIONAL | |
| ); | |

However there are several points of weakness which can prevent the appropriate operation of such mechanisms, some of which include an inability for the underlying platform to support a system reset which does not destroy memory states or an operating system not allowing a user to initiate such a reset request,

In some embodiments, the present inventive subject matter addresses this issue, among others, by enabling setting of a BIOS non-volatile variable and saving the appropriate information in an alternate non-volatile repository. This then allows a memory destructive reset to occur and allows the BIOS, upon reset, to pick up a pointer to the payload from the non-volatile variable indicator and retrieve it from its alternate non-volatile storage so that it can initiate the firmware update. In some embodiments, this may also include downloading the payload from a remote network location.

Another issue, amongst several, addressed by the inventive subject matter herein is when a remote administrator wants to push a BIOS update to a target system while the machine is operating in an operating system context. It should be noted that most platforms spend nearly 100% of their time in an operating system context. Today to enable an update, a platform-specific and operating system-specific agent needs to exist to receive this directive from the remote target because the out-of-band (“OOB”) device, such as an Active Management Technology (“AMT”) controller manageability engine (“ME”) or a typical baseboard management controller (“BMC”), does not have enough non-volatile storage to directly proxy such an update request. Some embodiments of the present subject matter allow initiation of communication with the out-of-band agent and have the out-of-band agent proxy a pointer to a remote payload. This is possible in such embodiments because the pointer is relatively miniscule in size compared to the payload itself, often-times several 10's of bytes versus multiple 1,000,000's of bytes, and the out-of-band agent can set a non-volatile repository which the BIOS can access after a system restart to retrieve the pointer. Thus, in such embodiments when the platform resets, the underlying BIOS can retrieve the pointer, download the requisite image, and initiate a firmware update as desired by a remote system administrator.

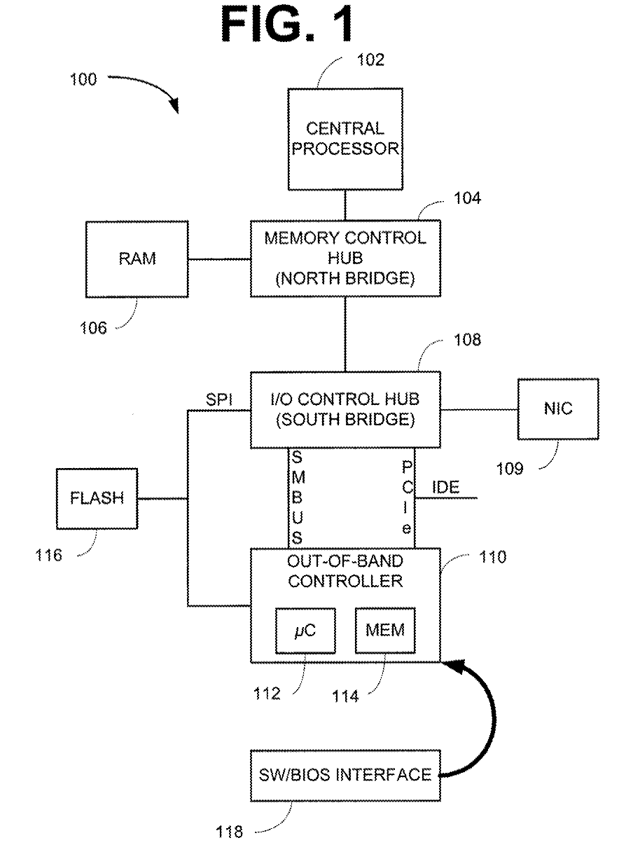

FIG. 1 is a logical schematic diagram of a system 100 according to an example embodiment. The example system 100 includes several interconnected components that provide a computing environment within which software maybe executed. The components may include, without limitation, a central processor 102 and random access memory 106 coupled to a memory control hub 104. The memory control hub 104 is also coupled to an I/O control hub 108. Coupled to the I/O control hub 108 is a network interface 109, an out-of-band controller 110 and one or more memories including at least one non- volatile memory, such as a flash 116 memory. Other memory and storage devices may also be coupled to the I/O control hub 108, such as one or more hard disk, floppy disk, writable optical disk, and other writable data storage devices. One or more display circuits, such as graphic cards or circuits may also be coupled to the I/O control hub 108.

The out-of-band controller 110 includes a microprocessor 112 and one or more memories 114 including one or more non-volatile memories. The out-of-band controller 110 may also be referred to as a manageability engine. The out-of-band controller 110 typically operates when a power source is available to the system 100. This includes even when the system 100 is powered off.

When a power supply is applied to the system 100, such as by plugging in a power cord of the system 100, the out-of-band controller 110 initializes. The initialization of the out-of-band controller 110 may include the out of band controller accessing an instruction set stored in anon-volatile memory, such as the flash memory 116 or a memory 114 within the out-of-band controller 110. The instruction set is executed by the microprocessor 112 to perform several functions. One such function may include initializing the network interface 109. The network interface 109 is typically a wired network interface device such as an Ethernet card or Ethernet circuit embedded in a board of the system 100. In some embodiments, the network interface 109 may be a wireless network interface, such as a WiFi or WiMax enabled wireless network interface device. Initializing the network interface 109 typically includes starting the network interface 109 and loading a network communication stack, such as a TCP/IP stack, to facilitate use of the network interface 109 by the out-of-band controller 110.

Another function facilitated by the out-of-band controller 110 instruction set is the ability to receive firmware update instructions over the network interface 109 and either apply the firmware updates or store then for later application when the system 100 is in an appropriate state for firmware updates to be applied or completed. An appropriate state for the firmware update to be applied or completed may be upon system 100 boot. In some embodiments, a BIOS interface 118 during system 100 boot may check one or more variables within a memory of the out-of-band controller 110 or the flash 116 to see if a firmware update is pending. As a result, the out-of-band controller 110 may be used to receive firmware updates even when the system 100 is powered off, but still plugged in, or otherwise connected, to a network.

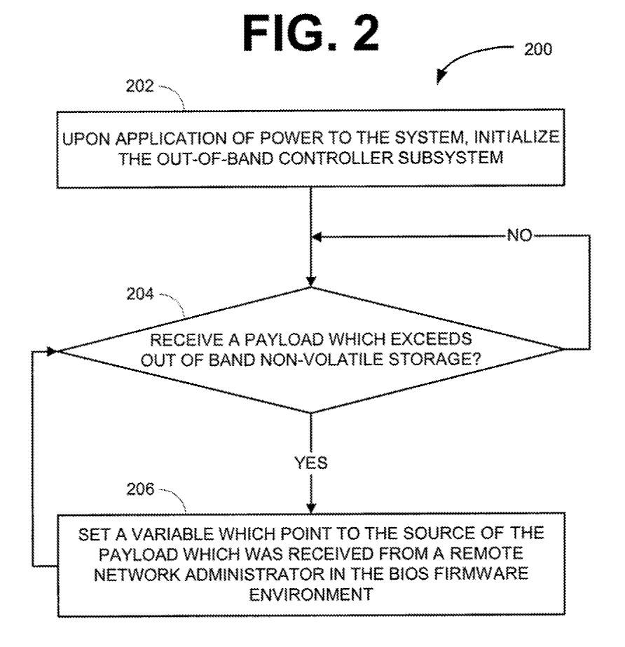

FIG. 2 is a logical block flow diagram of a method 200 according to an example embodiment. The example method 200 is a method that is typically performed by an out-of-band controller, but in some embodiments, may be performed by other devices, physical or virtual. The method 200 includes initializing an out-of-band controller subsystem upon application of power to a system 202. An out-of-band controller subsystem, in some embodiments, includes at least some devices coupled to an I/O control hub in a system. These devices may include an out-of-band controller, a non-volatile memory, a network interface, and other devices.

The method 200 further includes receiving a firmware update payload and determining if the payload exceeds storage space available in the out-of-band controller 204. The storage space may be exceeded in the event that more than one firmware update is received or firmware update requires a large instruction set. The firmware updates may include BIOS updates, operation code of various hardware devices within a system, an encryption key stored in a hardware device, or other firmware updates. If a firmware update payload does not exceed available out-of-band controller storage, the payload is stored in the out-of-band controller and the method iterates when a next payload is received. If the storage space is exceeded, the method 200 includes setting a variable which points to a source of the payload which was received, such as from a remote network administrator, in the BIOS firmware environment 206. This pointer, in various embodiments, may point to storage locations such as a non-volatile flash memory, a hard disk device, a network storage location, a web site, or other data storage location. In some instances, if more than one firmware update payload is received, more than one pointer may be stored. Each pointer may point to location on the same data storage device or two or more different devices. Once a firmware update instruction and payload is received, the firmware update may be applied. However, in some embodiments, the update is not applied until the system is in an appropriate state, such as when booting. In some embodiments, a firmware update may trigger a system boot.

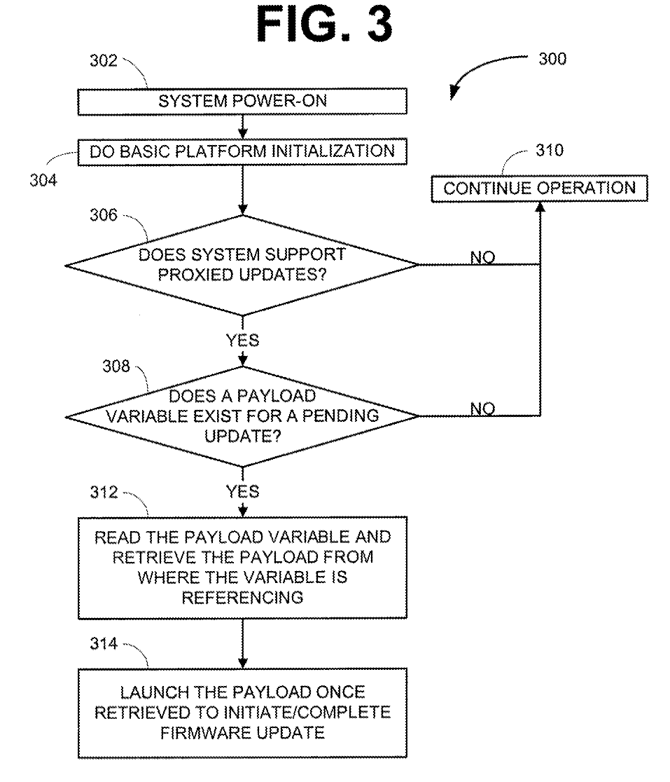

FIG. 3 is a logical block flow diagram of a method 300 according to an example embodiment. The method 300 is an example method of applying a firmware update payload at system boot. The example method 300 includes powering a system on 302 and performing a basic platform initialization 304. This basic platform initialization may include starting less than all devices the system and less than all processes of a BIOS of the system,

The method then determines if the system supports proxied update 306 and if the a payload variable exists for a pending update 308 as discussed above with reference to FIG. 2. If either of these determinations is negative, the system continues normal boot operations 310. However, if both determinations are positive, the method 300 includes reading the payload variable, or a first payload variable if more than one firmware update is pending, and retrieving the payload from where the variable Is referencing 312. The method then launches the payload to initiate or complete the firmware update 314. If another payload variable exists, the method then retrieves the next payload from where the variable is referencing 312 and launches that payload 314. The method 300 may continue to iterate until all firmware update payloads have been applied. However, in some embodiments, only one firmware update payload is applied per system boot.

In typical embodiments, following the launching of each payload and successful Implementation of the firmware update of an individual payload, the firmware update command payload variable and corresponding payload of the individual payload is deleted from the memory.

In some embodiments, when there is more than one firmware update payload to be applied, fee firmware update payloads may include designation of an order in which to apply the updates. The order may be specified in an event such as when the firmware updates need to be, or should be, implemented in a particular order. In some such embodiments, and others, following successful application of a firmware update, the method 300 includes resetting the system.

It is emphasized that the Abstract is provided to comply with 37 C.F.R. §1.72(b) requiring an Abstract that will allow the reader to quickly ascertain the nature and gist of fee technical disclosure. It is submitted with the understanding that it will not he used to interpret or limit the scope or meaning of fee claims.

In the foregoing Detailed Description, various features are grouped together in a single embodiment to streamline the disclosure. This method of disclosure is not to be interpreted as reflecting an intention that the claimed embodiments of the inventive subject matter require more features than are expressly recited in each claim. Rather, as the following claims reflect, inventive subject matter lies in less man all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
powering on a computing system that includes a BIOS;
initializing at least a portion of the BIOS;
if the computing system supports proxied firmware updates and a firmware update command payload variable exists in a memory, reading the firmware update command payload variable and retrieving the payload from a location referenced by the variable; and
launching payload once retrieved to implement the firmware update.

2. The method of claim 1, wherein if the computing system does not support proxied firmware updates or a firmware update command payload variable does not exist, the method further includes continuing initialization of BIOS.

3. The method of claim 1, wherein the firmware update command payload variable is received by a manageability engine via a network interface and stored in a non-volatile memory.

4. The method of claim 3, wherein the firmware update command payload variable is received by the manageability engine via the network interlace at a time when the computing system is powered off, but is connected to a power source.

5. The method of claim 1, wherein following the launching of each payload and successful implementation of the firmware update of an individual payload, the firmware update command payload variable of the individual payload is deleted from the memory.

6. The method of claim 1, wherein following the launching of the payload and successful implementation of the firmware update, the method further includes:
resetting the computing system.

7. The method of claim 1, wherein the payload implements a firmware update within a display circuit coupled to a motherboard of the computing system.

8. The method of claim 1, wherein retrieving the payload from a location referenced by the variable includes retrieving the payload from a non-volatile memory of the computing system.

9. A computer readable medium with instructions thereon, which when executed, cause a computing system to perform the method of claim 1.

10. An computing system comprising:
an out-of-band controller including a microprocessor and one or more non-volatile memories;
a network interface operatively coupled to the out-of-band controller;
a non-volatile flash memory operatively coupled to the out-of-band controller holding a firmware instruction set of the out-of-band controller, which when processed by the out-of-band controller, causes the out-of-band controller to:
initialize the microprocessor and one or more memories of the out-of-band controller;
initialize the network interface to facilitate communication by the out-of-band controller with network resources;
receive a firmware update payload from a remote network source over the network interface.

11. The computing system of claim 10, wherein the firmware instruction set of the out-of-band controller, when further processed, causes the out-of band controller to:
set a variable in the one or more non-volatile memories of the out-of-band controller that points to the remote network source of the firmware update payload if the firmware update payload exceeds available space in the one or more non-volatile memories of the out-of-band controller,

12. The computing system of claim 10, wherein if the firmware update payload exceeds available space in the one or more non- volatile memories of the out-of-band controller, storing the firmware update payload in at least one of the non-volatile flash memory and another writeable data storage device operatively coupled to the out-of-band controller.

13. The computing system of claim 10, further comprising:
a BIOS stored in a non-volatile memory of the computing system, which when initialized:
performs a basic platform initialization; and
if firmware update payload variable has been set by the out-of-band controller, launches a payload referenced by the firmware update payload variable.

14. The computing system of claim 13, wherein the payload implements a firmware update within a device coupled to a motherboard of the computing system.

15. The computing system of claim 14, wherein the device coupled to the motherboard of the computing system is a display circuit.
